(19) United States
(12) Patent Application Publication
(10) Pub. No.: US 2023/0297504 A1
(43) Pub. Date: Sep. 21, 2023

(54) EFFICIENTLY ALLOCATING MEMORY ON NEURAL NETWORK COMPUTE TILES

(71) Applicant: Google LLC, Mountain View, CA (US)

(72) Inventors: Jack Liu, Saratoga, CA (US); Dong Hyuk Woo, San Jose, CA (US)

(21) Appl. No.: 17/919,164

(22) PCT Filed: Apr. 26, 2021
(86) PCT No.: PCT/US2021/029236

§ 371 Date: Oct. 14, 2022

(51) Int. Cl. G06F 12/08; G06F 9/54

(52) U.S. Cl. CPC G06F 12/08; G06F 9/544

(57) ABSTRACT

Methods, systems, and apparatus, including computer programs encoded on computer storage media, for training giant neural networks. One of the methods includes obtaining data indicating a neural network comprising a plurality of layers; for each layer in a subset of the plurality of layers: assigning a subset of the plurality of computing units to at least partially perform inference computations associated with the layer; determining a memory size and a common memory address for the respective addressable memory unit of each computing unit assigned for the layer; and generating a shared instruction comprising a memory allocation instruction that, when executed by each of the subset of the plurality of computing units, causes the computing unit to store a result of performing inference computations associated with the layer in the determined common memory address with the determined memory size in the addressable memory of the computing unit.

### BACKGROUND

This specification generally relates to neural networks. In particular, this specification relates to processing inputs to a neural network on a hardware accelerator having multiple compute tiles.

Neural networks are machine learning models that employ one or more layers of nonlinear units to predict an output for a received input.

Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of network parameters.

The network parameters for a neural network are values that impact the operations performed by the neural network and that are adjusted as part of the training. For example, the network parameters can include values of weight matrices and, in some cases, bias vectors of the network layers of the neural network.

### SUMMARY

This specification generally describes techniques for generating instructions that cause computing units of a hardware computing system to efficiently allocate memory while processing inputs to certain types of neural network layers.

In general, one innovative aspect of the subject matter described in this specification can be embodied in methods that include the actions of obtaining data indicating (that is, defining) a neural network including a plurality of layers; selecting, from among the plurality of layers of the neural network, a subset of the plurality of layers based on the obtained data; for each layer in the subset of the plurality of layers, assigning, from among a plurality of computing units that each include a respective addressable memory unit, a subset of the plurality of computing units to at least partially perform inference computations associated with the layer; determining a memory size and a common memory address for the respective addressable memory unit of each computing unit in the subset of the plurality of computing units assigned for the layer; and generating a shared instruction including a memory allocation instruction that, when executed by each of the subset of the plurality of computing units, causes the computing unit to store a result of performing inference computations associated with the layer in the determined common memory address with the determined memory size in the addressable memory of the computing unit.

The actions in methods embodying the one innovative aspect of the subject matter further include providing the shared instructions to the plurality of computing units. The method can be performed by a computer system such as a hardware accelerator including the plurality of computing units. The computer system may further comprise a controller for controlling the plurality of computing units to perform parallel processing based on instructions transmitted by the controller to the plurality of computing units.

Another innovative aspect of the subject matter described in this specification can be embodied in methods that include the actions of providing a set of instructions for performing inference computations for a plurality of layers of a neural network to a system including a plurality of computing units. Each computing unit includes a respective addressable memory. The set of instructions includes a first memory allocation instruction associated with a first layer in the plurality of layers of the neural network, the first memory allocation instruction identifying a first memory address of the respective addressable memory and a first subset of the plurality of computing units; and a second memory allocation instruction associated with a second layer in the plurality of layers of the neural network, the second memory allocation instruction identifying a second memory address of the respective addressable memory and a second subset of the plurality of computing units. The second memory address differs from the first memory address, and the second subset differs from the first subset.

The set of instructions causes the system to, for each computing unit in the first subset, output results of inference computations associated with the first layer in the plurality of layers to a respective memory address of the computing unit's addressable memory based on the first memory address; and for each computing unit in the second subset, output results of inference computations associated with the second layer in the plurality of layers to a respective memory address of computing unit's addressable memory based on the second memory address.

Other embodiments of this aspect include corresponding computer systems, apparatus, and computer programs recorded on one or more computer storage devices, each configured to perform the actions of the methods.

The subject matter described in this specification can be implemented in particular embodiments so as to realize one or more of the following advantages.

A computing system that implements neural network models on a hardware accelerator having a plurality of computing units (e.g., compute tiles) can use the described techniques to efficiently perform inference computations for a neural network model by issuing a single, shared instruction for multiple computing units associated with a layer of the neural network model. The shared instruction specifies a shared memory address to which the computing units store, fetch, and aggregate partial results computed by the computing units associated with the layer. In some situations where, instead of employing the described techniques, the computing units have been assigned different memory addresses for storing results from inference computations in a particular layer, the system needs to issue multiple separate instructions for each of the computing units. However, the system adopting the described techniques can issue a shared instruction for passing to each computing unit in a particular layer, which can reduce the total number of instructions required by at least a factor N, where the factor N is the total number of computing units used for performing inference computations in a particular network layer.

The system can require less total instruction bandwidth and reduce memory usage due to issuing the shared instruction. Therefore, in a context in which the system (which may be a hardware accelerator) includes a controller which controls it, and the instruction bandwidth and memory of an instruction memory of the controller are constrained, the system can directly load the shared instructions into the controller's instruction memory instead of fetching a portion of separate instructions from a host to the controller at each of multiple times. In this way, the system can reduce and even eliminate time waste in transmitting portions of separate instructions. In some implementations, the described techniques can reduce more than 50% of the total instruction bandwidth requirement for conventional methods.

Moreover, the system adopting the described techniques can perform inference computations for sizeable neural network models. Previously, it has been difficult or even impossible to compute large neural networks on specific hardware accelerators. Because the number and size of instructions needed for allocating memory for inference computations of large neural networks scale up with the neural networks and the number of network layers, the total instruction size can be enormously significant. For large-sized instructions, a system needs to transmit portions of separate instructions from a host to a controller multiple times, which is inefficient and can increase downtime overheads. Moreover, it is error-prone for the system to correctly fetch portions of a plurality of separate instructions from the host to the controller for large neural networks with iterative loops.

However, if the system issues shared instructions described in this specification, the instruction size can be significantly decreased. Therefore, the system can directly load all the shared instructions to avoid fetching instructions from a host multiple times, reducing downtime (e.g., reducing time spent on loading shared instructions) and to avoid potential errors when fetching instructions for computing neural networks with iterative loops.

In addition, the described techniques can reduce memory usage. For example, the system, using the shared instructions, can decrease memory allocation for storing activation inputs, weight inputs, and hyper-parameters for a particular machine learning model in a computing unit (e.g., a GPU or a TPU), which can eventually improve computation efficiency, for example, of performing inference computations of a particular machine learning model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example hardware computing system for performing inference computations of neural network models.

FIG. 2A illustrates an example of conventional memory allocation for compute tiles associated with a layer of a neural network model.

FIG. 2B illustrates an example of common memory allocation for compute tiles associated with an eligible layer of a neural network model.

FIG. 3 illustrates an example allocation of an extra memory address for compute tiles associated with a fully-connected layer of a neural network model.

FIG. 4 illustrates an example detailed architecture for a compute tile in the system.

FIG. 5 illustrates an example process for memory allocation of compute tiles in the system for performing inference computations for neural network models.

### DETAILED DESCRIPTION

This specification describes techniques for improving inference computation efficiency of a hardware computing system that includes multiple computing units when processing inputs in a neural network model.

Each computing unit of the hardware computing system is self-contained and can independently execute computations required by at least a portion of a given layer of a multilayer neural network. The described techniques can reduce the required instruction memory size and improve the computation efficiency in the hardware computing system when performing inference computations for a deep or large neural network model.

A trained neural network model having multiple layers can be used to compute inferences. For example, given an input, the neural network can compute an inference for the input.

The neural network computes the inference by processing the input through each of the neural network layers. In particular, at least some of the neural network layers each have a respective set of weights. Each layer receives an input and processes the input in accordance with the set of weights for the layer to generate an output.

Data inputs to a neural network layer, e.g., either the input to the neural network or the outputs of one or more other layers in the neural network, can be referred to as activation inputs to the layer.

In some implementations, the layers of the neural network are arranged in a sequence. In other implementations, the layers are arranged in a directed graph.

That is, any particular layer can receive multiple inputs, or generate multiple outputs, or both. The layers of the neural network can also be arranged such that an output of a layer can be sent back as an input to a previous layer.

Each layer of a neural network model can have a respective type, e.g., as defined by the inter-layer nodal connections of the neural network.

As an example, one type of layer in the neural network model can be a fully-connected layer. For a fully-connected layer, every node in this type of layer is connected with all nodes of at least one neighboring layer, i.e., with at least one other layer in the neural network from which the fully-connected layer receives nodal input. For example, when a given layer is a fully-connected layer, and the network layers are arranged in a sequence, each node of the given layer is connected to all nodes in a preceding layer to the given layer in the sequence.

A fully-connected layer can be found in different neural networks. For example, fully recurrent neural networks (FRNN) include merely fully-connected layers. The simplest form of an FRNN can be a multilayer perceptron (MLP), including an input layer, an output layer, and one or more hidden layers, each of which is a fully-connected layer. In addition, conventional recurrent neural networks can also include one or more fully-connected layers. As for convolutional neural networks (CNN), a fully-connected layer is typically located as one of the last few CNN network layers. A fully-connected layer in a CNN can receive nodal outputs from all nodes in a previous convolutional layer to generate nodal outputs for classifying or labeling the input data. For example, a fully-connected layer can be the second last layer, followed by a SoftMax layer of the CNN.

As another example, another type of layer is an element-wise layer. Element-wise layer operates on input data element by element, e.g., element-wise add, element-wise multiplication, and element-wise nonlinear operations. In some implementations, each node of an element-wise layer is connected to only one of the nodes in a neighboring layer. That is, each node in an element-wise layer performs an operation on an input that is received from a corresponding single node in the neighboring layer.

One example element-wise layer can be a network layer where each node in the layer includes a respective nodal operation of a respective activation function (e.g., Relu or Sigmoid function), in which each node receives only one nodal input from a neighboring layer. Another example element-wise layer can be a network layer for nodal residual connections. More specifically, each node in the layer includes a residual function that receives a single input from a node in a neighboring layer, and outputs a residual to be added to a corresponding residual input to a succeeding layer. Optionally, each node in the layer can also include a non-linear function applying to the nodal residual.

The element-wise nodal operation can include any suitable operations, e.g., element-wise add, subtraction, and multiplication. For example, an element-wise nodal output can be the addition of corresponding two elements according to the nodal operation in an element-wise fashion.

The neural network can also include other layers with a different type, such as average-pooling layers or convolutional layers, where inter-layer nodes are partially connected. Each node in the layer is connected to a respective subset of nodes in the neighboring layer.

To perform inference computations for a neural network model, i.e., to compute an output for a given input, a hardware computing system distributes some or all of the layers of the neural network to a plurality of computing units (also referred to as “compute tiles”) within the hardware computing system such that each computing unit can perform operations (e.g., tensor computations) for at least a portion of the assigned layer.

For certain types of layers, e.g., element-wise and fully-connected layers, the computation of the layer is distributed across each of the plurality of computing units. Each computing unit outputs at least a respective partial result obtained from performing associated inference computations of the layer and stores the respective partial result to one or more memory addresses in a respective addressable memory unit of the computing unit.

In some implementations, each computing unit can have a respective addressable memory unit directing to one or more memory addresses in a memory device.

To generate at least a portion of layer output from partial results generated by the assigned computing units for the layer, the system can generate separate instructions for each computing unit. The separate instructions can include data determining one or more respective memory addresses for storing the respective partial results, and data determining whether respective partial results for a computing unit would be used for generating the at least a portion of the input to another layer. More specifically, because one or more compute tiles assigned to a succeeding layer might need to copy or combine partial results from one or more compute tiles in a preceding layer, the system needs to generate separate instructions for tiles in the succeeding layer, each of which specifies respective memory addresses where relevant partial results are stored for the tile to correctly fetch the partial results. The more compute tiles are assigned to the particular network layer, the more separate instructions are needed to specifying different memory addresses. Thus, the number and size for instructions scale up with the increase of the total number of computing units assigned to the layer, and the instructions might exceed the memory limit.

When the total separate instructions exceed the system's memory limit, the system becomes less efficient when transmitting all instructions from a host to a controller. More specifically, the system, for each time, needs to transfer a portion of instructions from the host, and copy the portion of instructions in the instruction memory of a controller included in the system. Moreover, if the neural network model is considerably large and includes iterative loops for performing inference computations, the system cannot perform inference computations for these neural network model using conventional methods. Iterative loops for performing inference computations of neural network models are present in many neural network models deployed on neural network accelerator chips, either on-device or in the cloud. Therefore, it is of great interest to find a feasible way to perform inference computation of such neural networks efficiently. Examples of neural network models whose computations require iterative loops include long short-term memory (LSTM) models or recurrent neural network (RNN) models, such as WaveRNN, OCT, and RNN-T.

The techniques described in the specification below can address the problem mentioned above.

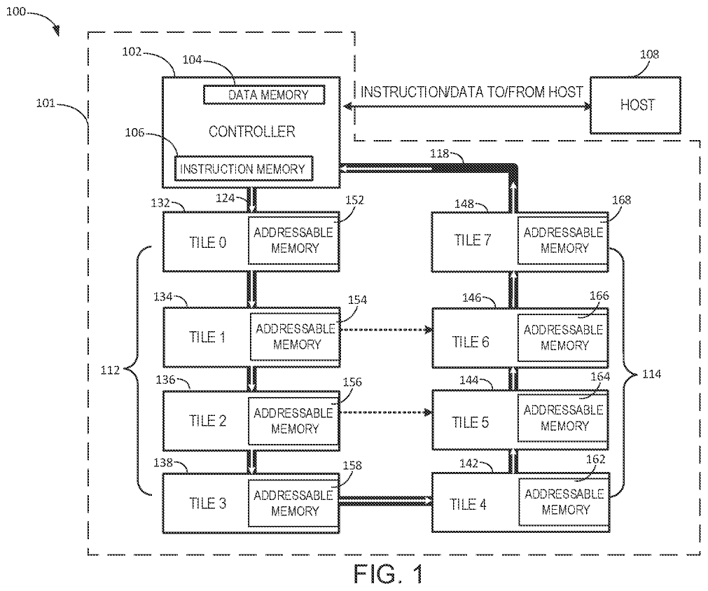

FIG. 1 shows an example hardware computing system 100 for performing inference computations of neural network models.

The system 100 includes a hardware accelerator 101 (also referred to as integrated circuitry or a chip in the following specification, although in some implementations it may be implemented as multiple physically-separate integrated circuits) and a host 108 that is located off-chip and is configured to communicate with the hardware accelerator 101 over a wired or wireless connection.

The host 108 can be implemented as one or more computer programs on one or more hardware devices that are located off-chip, i.e., that are not part of the hardware accelerator 101, and generates instructions for controlling the operation of the hardware accelerator 101.

As shown in FIG. 1, the hardware accelerator 101 includes a controller 102, a plurality of tiles 132-148 referred to collectively as compute tile sets 112, 114, and chip memory (not shown).

The controller 102 generally includes data memory 104, instruction memory 106, and at least one processor configured to execute one or more instructions encoded in the instruction memory. Instruction memory 106 can store one or more machine-readable instructions that are executable by one or more processors of controller 102. The instruction memory 106 includes a memory of a particular size, e.g., 256 kB. Data memory 104 may be any of a variety of data storage media for storing and subsequently accessing various data relating to computations within the system 100.

The controller 102 can receive instructions and data parameters from the host 108 and is configured to provide the instructions to multiple compute tiles through the instruction bus 124 (described below).

The data parameters relate to data defining a neural network model and input data to the neural network model.

In general, it is ideal for the controller 102 to receive all instructions from the host 108 at an initial time and store them in instruction memory 106. In this way, during inference computations, the controller 102 can avoid fetching portions of instructions during computations, which can lead to errors introduced by iterative loops in a neural network. For neural networks without iterative loops, rare but possible, the controller 102 can be configured to receive a portion of all instructions for computing these neural network models at a time and fetching other portions each at a different time. Optionally, the controller 102 in the system 100 can be configured to, after at least a portion of the previously stored instructions have been executed, further receive more instructions from the host 108 and store them in the instruction memory 106.

The controller 102 can instruct one or more compute tiles for performing inference computations for at least a portion of the neural network model.

Each compute tile is an individual computing unit that cooperates with other compute tiles in the system 100 to accelerate computations across one or more layers of a neural network model. As shown in FIG. 1, the compute tile set 112 includes compute tile 0, compute tile 1, compute tile 2, and compute tile 3 (i.e., tiles 132, 134, 136, and 138), each of which includes an addressable memory unit 152, 154, 156, and 158, respectively. The compute tile set 114 is made up of compute tiles 142-148 which include addressable memory units 162, 164, 166, 168 respectively. Each compute tile can, after performing inference computations, store a partial result at a respective memory address within the respective addressable memory unit according to a respective instruction broadcasted by the controller 102.

The instructions can each include a respective header (e.g., a bitmap) indicating which compute tile should execute the instruction.

The controller 102 can broadcast instructions for each compute tile. More specifically, the controller 102 can broadcast the received instructions from the host 108 to each compute tile along the data path 118 using the instruction bus 124: i.e., the instructions stored in the instruction memory 106 can be transmitted by the instruction bus 124 originating from controller 102 and providing communications through a data path 118 that connects each compute tile in compute tile sets 112, 114 in a ring back to controller 102. During transmitting one or more instructions in the instruction bus 124, the instructions may, for example, be 32-bits wide with the first 7-bits including header information indicating the instruction address/destination that is to receive and execute the instructions. For example, the first 7-bits may contain data parameters that represent a particular node ID. Each compute tile along the data path 118 may sequentially inspect the header of the instructions to determine if the request by the host 108 was addressed to the compute tile inspecting the header.

When the node ID of the header does not indicate that the destination is the inspecting tile, the inspecting tile will copy the input instruction packet to the instruction bus connecting to the next tile for inspection by the next tile. When the node ID of the header does indicate that the destination is the inspecting tile, the inspecting tile will perform operations encoded in the input instruction packet.

The instructions can include data in the header (e.g., one or more node IDs) to specify a subset of compute tiles for performing computations among all tiles. The subset of compute tiles is assigned to perform computations within a specific layer of a neural network. Each compute tile of the subset performs inference computations of a respective non-overlapping portion of the assigned layer. For example, each compute tile of the same tile set (compute tiles 132, 134, 136, and 138 in the tile set 112) can be assigned to the same layer of a neural network model and perform inference computations associated with the layer.

The instructions can further specify one or more memory addresses within corresponding compute tiles to output data to. To solve the problems mentioned above of instructions having a size exceeding the size limit of the instruction memory 106, the host 108 can generate a shared instruction for the respective subset of compute tiles assigned to a particular network layer. The shared instruction for the particular network layer can specify a memory size and a common memory address for each compute tile in the subset. The shared instruction for each layer can have data (e.g., one or more node IDs) to identify each compute tile, and cause the compute tile to store partial results in its respective addressable memory unit at the respective common memory address with the respective same memory size. In some implementations, the controller 102 can, based on a respective shared instruction for each layer, generate a plurality of instruction packets for the layer, each having a node ID for a corresponding tile associated with the layer, and the common memory address for the corresponding tile to store partial results having the same memory size.

The controller 102 can, according to the instructions, combine the stored partial results generated by each of the associated compute tiles from the common memory address for generating a final output from the neural network for a given input. More specifically, the controller 102 can instruct one or more compute tiles in a succeeding layer to combine partial results from previous layers stored in the common address in the previous layer. After completing inference calculations for a neural network, the controller 102 can instruct compute tiles in the last layer of the neural network to generate a final output. The controller 102 can then provide the final output to the host 108.

Thus, to cause the hardware accelerator 101 to perform inference operations for a neural network deployed on the hardware accelerator, the host 108 generates and transmits a plurality of instructions to the controller 102. The plurality of instructions, once executed by one or more compute tiles in the hardware accelerator 101, can cause the one or more compute tiles to perform respective inference operations for a least a portion of the neural network according to the plurality of instructions.

The plurality of instructions issued by the host 108 adopting the described techniques can be shared instructions for multiple compute tiles assigned to one or more eligible network layers. The details of allocating memory of each compute tile assigned to a network layer using a shared instruction will be described in more detail below.

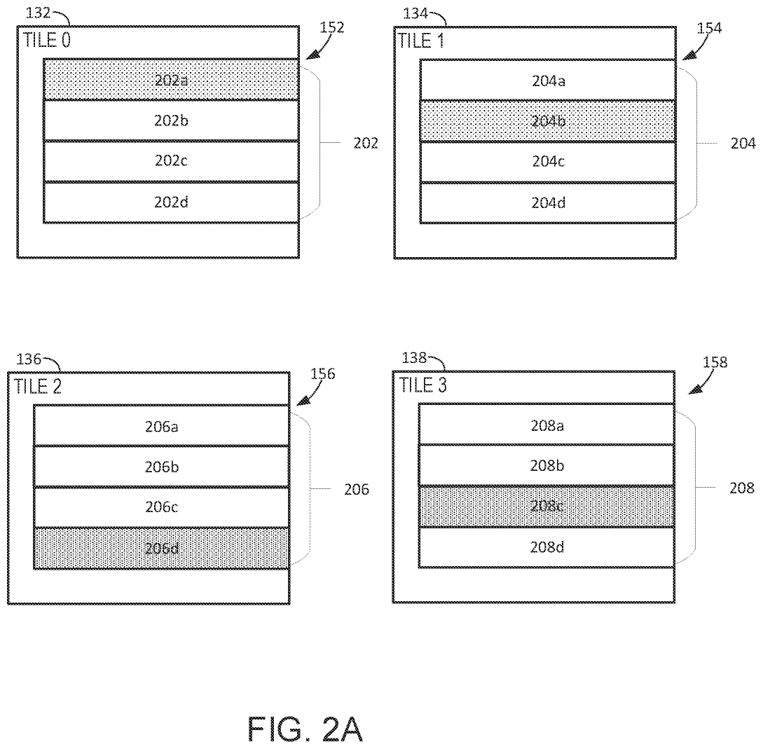

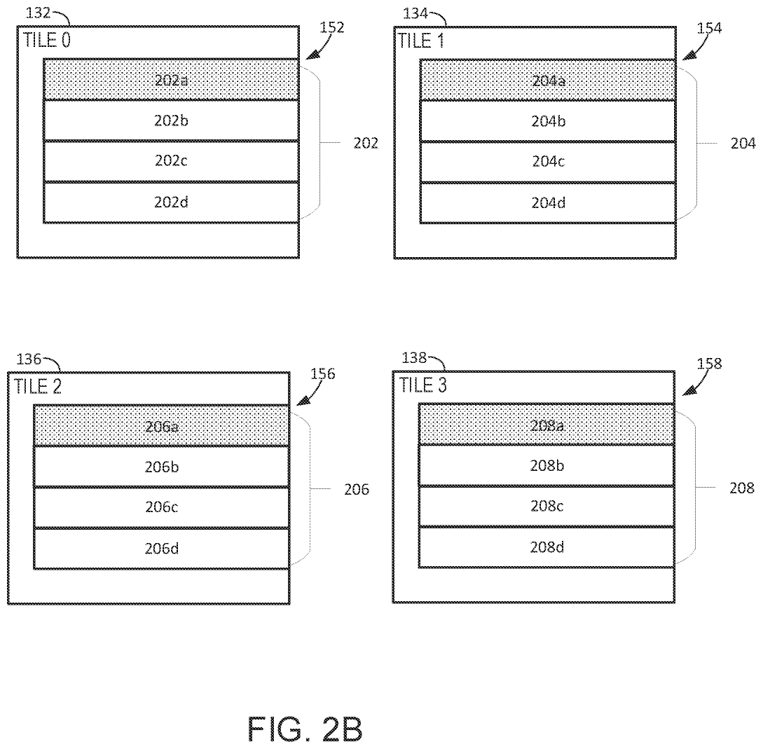

FIG. 2A illustrates an example of conventional memory allocation for compute tiles 132, 134, 136, and 136 associated with a layer of a neural network model.

The host 108 can generate and provide to the controller 102 data for assigning operations represented by each layer of a neural network model to a respective subset of all available compute tiles. Each tile of the respective subset of tiles can perform at least a non-overlapping portion of the operations for an associated layer. For example, the host 108 can determine and assign operations in a particular layer of the neural network to the first compute tile set 112, which includes compute tiles 132, 134, 136, and 138, and so that each compute tile performs at least a non-overlapping portion of inference computations.

Each compute tile can include a respective addressable memory unit, and each respective addressable memory unit can include a plurality of memory addresses. For example, tile 132 includes an addressable memory unit 152 with different memory addresses 202, e.g., 202a, 202b, 202c, and 202d.

Conventionally, a controller 102 is configured to broadcast a separate instruction to each tile assigned to the same network layer. Each of the separate instructions can include a respective memory allocation instruction for the corresponding tile. The memory allocation instruction can identify a respective memory address for the respective addressable memory unit of the corresponding compute tile to store a respective partial result. Each respective partial result is generated by a corresponding compute tile performing a respective portion of inference computations for a respectively assigned layer given an input.

Referring to FIG. 2A as an example, a particular layer is assigned to the first compute tile set 112, including compute tiles 132, 134, 136, and 138. Each of the compute tiles performs at least a portion of the inference computations for the particular layer. The inference computations can include, for example, tensor computation of a portion of the input activations with corresponding layer weights. After obtaining a respective partial result from the corresponding portions of inference computations, each compute tile stores the respective partial result into a different memory address according to a respective conventional instruction for the tile. For example, as shown in FIG. 2A, compute tile 132 outputs the respective partial result to the memory address 202a of the addressable memory unit 152 according to a first conventional instruction. Similarly, compute tile 134 outputs to the memory address 204b according to a second conventional instruction, compute tile 136 outputs to the memory address 206d according to a third conventional instruction, and compute tile 138 outputs to the memory address 208c according to a fourth conventional instruction.

Conventional instructions for a given neural network layer, when executed by tiles associated with the layer, can cause the tiles to perform at least a respective portion of inference computations for the layer, generate respective partial results, and store the partial results at different memory addresses in respective addressable memory units of the tiles. It can be beneficial to do so because, for example, if the layer following the given layer is a fully-connected layer and therefore each tile associated with the following layer needs the entire output of the given layer in order to compute even a partial output of the following layer, each of the one or more tiles associated with the following fully-connected layer can directly copy each of the partial results stored from the different memory addresses associated with the preceding layer to the same memory addresses in the local memory of the tile.

More specifically, in connection with FIG. 2A and according to conventional instructions, tiles 132, 134, and 136 can be assigned to a first layer, and tile 138 can be assigned to a fully-connected layer succeeding the first layer. The tiles 132, 134, and 136 can obtain respective partial results for performing inference computations in the first layer, and store the respective partial results in memory address 202a, 204b, and 206d, respectively. The respective partial results collectively include a full set of nodal outputs from the first layer. To obtain one or more input activations for the succeeding fully-connected layer, the tile 138 can directly copy the respective partial results from address 202a of the tile 132 to address 208a of tile 138, from 204b to 208b, and from 206d to 208d, without allocating another memory address in the tile 138 for storing the full set of nodal outputs.

However, because one or more tiles in the first layer store partial results in different local memory addresses, and one or more tiles in the succeeding layer (e.g., a fully-connected layer) need to copy each of the partial results stored from the different local memory addresses, the host 108 needs to generate respective instructions specifying memory addresses for tiles in the first layer to store respective partial results, and respective instructions specifying respective memory addresses for each of the tiles in the succeeding layer from which to collect partial results.

To speed up performing inference operations for a particular neural network, a system tends to use as many tiles as possible for parallelization. The total size of instructions therefore increases to different extent based on respective parallelization levels.

Moreover, the more tiles assigned to a particular layer, or the more nodes in the succeeding fully-connected layer, the greater number of separate instructions are needed for tiles associated with the particular layer to store partial results, and for tiles associated with the succeeding layer to copy or combine partial results from the particular layer. Thus, as described above, the size of instructions for performing inference computations for a neural network scales up with the number of compute tiles associated with each layer, and the layer size (i.e., number of nodes in a layer).

The increasing size of instructions can harm the efficiency of performing inference computations for a neural network, particularly for large neural networks.

However, the compute system 100 described below can solve this problem.

In connection with FIG. 1, the compute system 100 can first obtain data for the host 108. The data can represent a neural network with a plurality of layers, and a layer type for each of the plurality of layers: e.g., an element-wise layer or a fully-connected layer.

The host 108 can determine and select a subset of layers of all layers of the neural network indicated by the received data. For simplicity, this subset of layers of the neural network will be referred to as eligible layers. Thus, the eligible layers are those layers which meet a eligibility criterion. The eligible layers include layers that are either of an element-wise type or a fully-connected type.

The host 108 can generate respective shared instructions each for compute tiles associated with a respective eligible layer.

Each shared instruction for the tiles associated with an eligible layer may include at least a memory allocation instruction that specifies a common memory address and a pre-determined memory size for the associated tiles. Each compute tile can store respective partial results at the common memory address with the pre-determined memory size. The pre-determined memory size may be determined by the host 108 or set by a user. The memory size may be determined based on the number of values in the partial results that each tile needs to output after performing the assigned portion of computations in the layer. For example, the memory size for an element-wise layer assigned to tiles each associated with at least five nodal computations may be greater, than an element-wise layer assigned to tiles each associated with no more than two nodal computations. As another example, a fully-connected layer may require a smaller memory size than an element-wise layer, depending on how many values each associated tile needs to output.

In addition to storing respective partial outputs to a common memory address for tiles associated with an eligible layer, the host 108 can also generate shared instructions for tiles associated with a fully-connected layer to aggregate stored data from a preceding layer. The preceding layer can be any proper eligible layer, e.g., a fully-connected layer or an element-wise layer.

The host 108 can also generate the shared instruction for the fully-connected layer further including a shared aggregation instruction that specifies an extra memory address. The shared aggregation instruction, when executed by the tiles, can cause each tile associated with the fully-connected layer to obtain partial results representing all nodal results of the preceding layer stored in a common address, and aggregate the obtained partial results in the extra memory address. This is because even if a compute tile associated with the fully-connected layer is assigned to only a portion of layer operations, the compute tile still needs to obtain a full set of results from the preceding layer.

The term “aggregation” refers to combining all nodal outputs from a preceding eligible layer into a suitable input activation for one or more nodes in the succeeding fully-connected layer. More specifically, the aggregation instruction issued by the host 108, when executed by each tile associated with respective nodes in the fully-connected layer, can cause the tiles associated with respective nodes in the fully-connected layer to gather (e.g., copy and store) a full set of nodal outputs from the common address associated with the preceding layer, and construct a respective input activation each for a respective node in the fully-connected layer based on the gathered full set of nodal outputs at the extra common address specified in the shared aggregation instruction. The generated respective input activation (or aggregated partial results) according to the aggregation instruction can be used as input for the fully-connected layer to generate partial outputs by respective tiles.

The gathered results by the tiles for a fully-connected layer are usually greater in size than respective partial results stored in the common memory address in the respective addressable memory of each compute tile assigned to the preceding layer. Therefore, the shared aggregation instruction generated by the system 100 can specify an extra common address having one or more extra common memory addresses, each with a different size. For example, the extra common address can be a single extra common address with a greater memory size than the common address for storing partial results for a layer. As another example, the extra common address can include one or more extra common addresses for a fully-connected layer, each having a different size. The total number of the extra common addresses and respective sizes for each of the extra common addresses can be determined based on the layer size of the preceding layer, or the size of the gathered partial results from the preceding layer.

Each compute tile associated with the fully-connected layer, according to the shared instruction issued by the host 108, performs at least a respective portion of inference computations of the fully-connected layer for processing the aggregated input activations, and generates a respective partial result to store in a common memory address according to the shared instruction for the fully-connected layer.

For an element-wise layer, the shared instruction does not need to specify another memory address besides the common memory address. Each tile associated with the element-wise layer, according to the shared instruction issued by the host 108, does not need to aggregate respective partial results associated with a preceding layer, or aggregate respective partial results associated with the current layer to form input activations for the next layer. Instead, each nodal input activation of an element-wise layer is the nodal output activation from the preceding layer, and each output activation of the layer is the nodal input activation to a succeeding layer. Therefore, a compute tile of the next layer can directly copy the output activations stored at a common memory address of a corresponding compute tile associated with a preceding layer according to the shared instruction.

FIG. 2B illustrates an example of common memory allocation for compute tiles 132, 134, 136, and 138 associated with an eligible layer of a neural network model.

As shown in FIG. 2B, the host 108 generates a shared instruction for each compute tile 132, 134, 136, and 138 assigned to an eligible layer. The shared instruction specifies a common memory address for each compute tile to store a respective partial result at a common address in the respective addressable memory units 152, 154, 156, and 158. The common address may be a memory location on the chip memory, that, for each respective addressable memory unit for each compute tile, at least a respective portion in each respective addressable memory unit is configured to “point” to, when the corresponding tiles access data stored at the common address for a particular layer. For example, compute tiles 132, 134, 136, and 138 each generate a respective partial result obtained by performing a respective portion of inference computations in the associated layer, and store the respective partial results at the common address. In some implementations, the respective memory addresses 202a for the tile 132, 204a for the compute tile 134, 206a for the compute tile 136, and 208a for the compute tile 138 all “point” to the common memory address. Because each compute tile stores respective partial results at the common address, the stored partial results can also be accessed by other compute tiles using a shared instruction. Therefore, the host 108 can reduce instruction size by generating shared instructions for compute tiles to access the common memory address for fetching stored partial results.

In some implementations, the shared instruction for tiles associated with a layer can include both data storing and accessing, which further decreases the memory bandwidth requirement for receiving instructions from the host 108 and broadcasting the instructions using the controller 102.

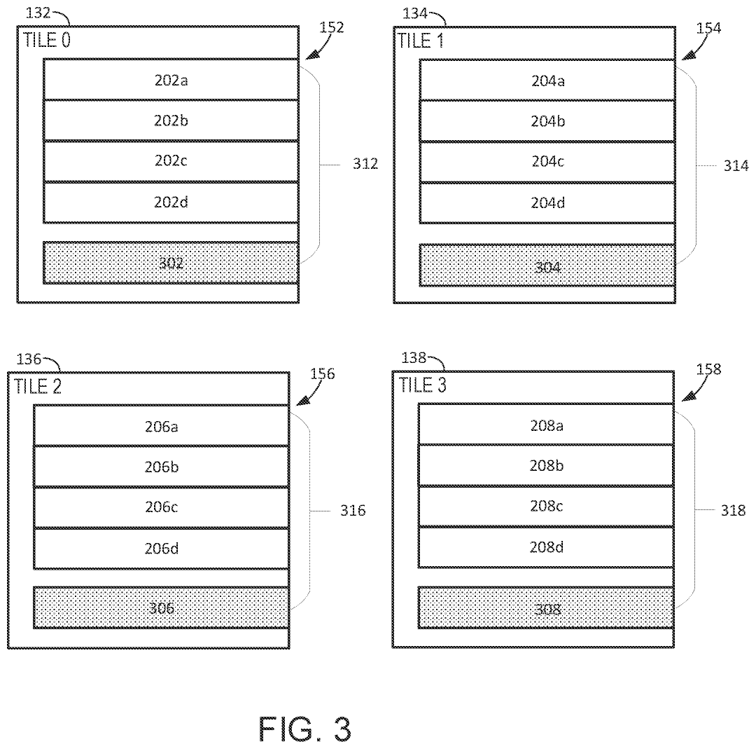

FIG. 3 illustrates an example allocation of an extra memory address for compute tiles 132, 134, 136, and 138 associated with a fully-connected layer of a neural network model.

As described above, for each of the fully-connected layers, in addition to the respective common address for tiles to store partial results after performing respective portions of computations in the particular fully-connected layer, the host 108 can generate a shared instruction specifying an extra memory address for tiles associated with the particular fully-connected layer to combine partial results from a preceding eligible layer. More specifically, each tile associated with the fully-connected layer can copy and combine a full set of nodal outputs from the preceding layer at the extra memory address. The aggregated results are used as respective nodal activation inputs for performing inference computations in the fully-connected layer. Even if a tile associated with the fully-connected layer performs only a portion of operations of the layer, the tile is instructed to obtain all the nodal outputs stored in the common address from the preceding layer, and combine the nodal outputs in the extra memory address in the layer.

In some implementations, the host 108 can identify each nodal output (e.g., by a number or an ID associated with nodal output) in the partial results stored in the common memory address for the preceding layer, so that the tiles in the fully-connected layer can copy and non-repeatedly combine each of the identified nodal outputs from the preceding layer in the extra memory address.

Assume that tiles 132, 134, 136, and 138 are associated with a fully-connected layer, and the preceding layer to the fully-connected layer is an eligible layer. As shown in FIG. 3, each tile allocates an extra memory address in a respective addressable memory unit according to the shared instruction for these tiles. For example, the memory unit 152 of tile 132 is configured to include an extra memory address 302, the memory unit 154 of tile 134 includes an extra memory address 304, the memory unit 156 of tile 136 includes an extra memory address 306, and the memory unit 158 of tile 138 includes an extra memory address 308. Each extra memory address of the respective memory unit is associated with an extra common address on the chip memory.

According to the aggregation instruction of the shared instruction for the tiles associated with the fully-connected layer, each tile obtains a full set of nodal outputs from stored partial results in the common address for the eligible preceding layer, and aggregates the nodal outputs at the respective extra memory address. For example, the compute tile 132 copies and combines partial results from the preceding eligible layer at the memory address 302 of the memory unit 152, the compute tile 134 copies and combines partial results from the preceding eligible layer at the memory address 304 of the memory unit 154, the compute tile 136 copies and combines partial results from the preceding eligible layer at the memory address 306 of the memory unit 156, and the compute tile 138 copies and combines partial results from the preceding eligible layer at the memory address 308 of the memory unit 158.

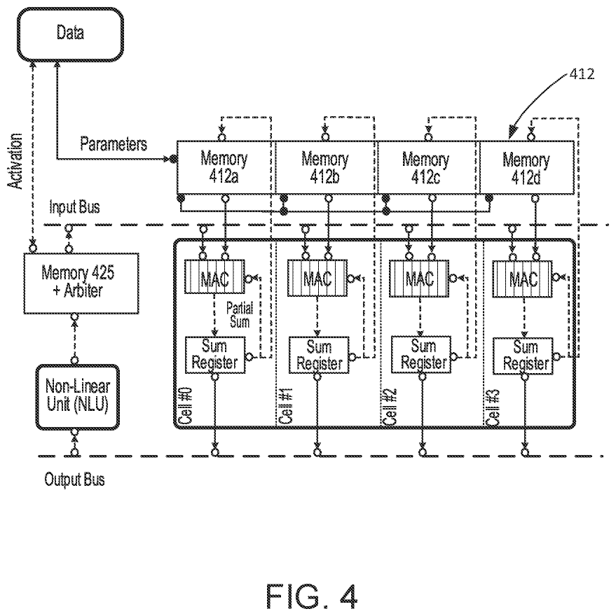

As a more specific example, FIG. 4 illustrates an example detailed architecture for a compute tile 132 in the system 100.

As shown in FIG. 4, the example compute tile 132 can include both narrow memory 425 unit and wide memory unit 412a, 412b, 412c, 412d (collectively 412). Narrow and wide designations generally refer to a size in width (bits/bytes) of the memory units of narrow memory 425 and wide memory 412. In some implementations, narrow memory 425 includes memory units each having a size or width of less than 16-bits, and wide memory 412 includes memory units each having a size or width or less than 32-bits.

Generally, the compute tile 132 assigned to an eligible layer receives data, including input activations and parameters from the host along the data path 118. The compute tile 132 writes the input activations into narrow memory 425 and the parameters into wide memory 412 according to a shared instruction for the eligible layer. In some implementations, narrow memory 524 can include a memory arbiter typically used to decide, for each memory cycle, which control device (e.g., TensorOp control or DMAOp control) will be allowed to access the narrow memory 210.

If the eligible layer is fully-connected and the layer preceding fully-connected layer is also an eligible layer, the compute tile 132 aggregates at an extra memory address indicated by the shared instruction, a full set of nodal outputs from the partial results obtained for the preceding layer.

More specifically, compute tile 132 performs a respective portion of inference computations associated with a particular layer of the neural network by MAC operators and sum registers. The compute tile 132 provides input activations for the layer, from the narrow memory 425 along the input bus, to one or more MAC operators. The compute tile 132 also provides parameters from the wide memory units 412 to one or more MAC operators. The one or more MAC operators and sum registers perform arithmetic operations relating to dot product computations and summations using the input activations and parameters.

The compute tile 132 provides the partial result generated from the MAC operators and sum registers to a Non-linear Unit along an output bus. The non-linear unit is configured to apply a non-linear function, e.g., a Sigmoid, or ReLU function, over the partial result to generate at least a portion of output activation for the succeeding layer. The compute tile 132 stores the output activations at the common address allocated in the narrow memory unit 425 according to the shared instruction for the layer. Other compute tiles associated with the next layer can fetch the stored output activation from the narrow memory unit of the compute tile 132. In some implementations, the shared instruction for a layer can include data determining whether the stored partial results from one or more compute tiles of the layer will be used for generating input activations for compute tiles associated with a succeeding layer, and if so, where the stored partial results will belong to a final result (e.g., input activations for a succeeding layer or a final output for the neural network).

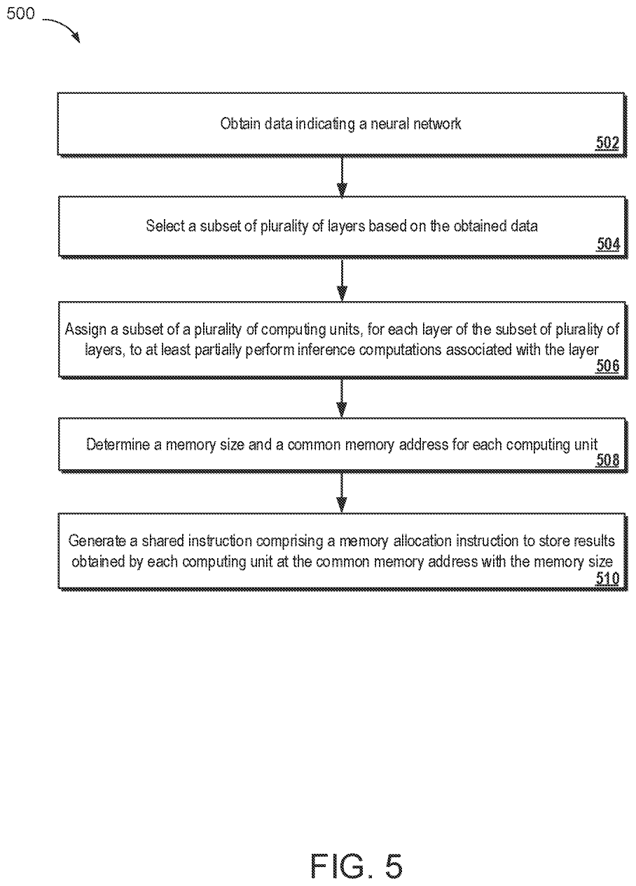

FIG. 5 illustrates an example process 500 for memory allocation of compute tiles in the system 100 for performing inference computations for neural network models. For convenience, the process 500 will be described as being performed by a system of one or more computers located in one or more locations. For example, a hardware computation system, e.g., the system 100 of FIG. 1, appropriately programmed, can perform the process 500. As a more specific example, a host, e.g., the host 108 of the system 100 of FIG. 1 can perform the process 500 if appropriately programmed.

The host first obtains data indicating a neural network. (502) Data indicating a neural network includes data specifying a type of the neural network (e.g., a convolutional neural network, or a recurrent neural network), a total number of layers in the neural network (e.g., ten hidden layers between the input layer and the output layer), a number of nodes of each layer (e.g., 10, 20, or 50 nodes, each of which includes at least a network operation), data representing a sequence of all layers, and data representing inter-layer nodal connections (e.g., whether a layer is fully-connected, partially-connected, or element-wise connected with one of the neighbor layers). In some implementations, the data can include parameters that further define a trained neural network, such as a learned set of weights for each node associated with each layer, data format requirements for the input layer, or the output layer, or both (e.g., data representing requirements for the size of input data for the input layer in the trained neural network, or data representing output format such as the number of output categories for the trained neural network). In some implementations, the host can determine if the data represents an untrained neural network or a trained neural network but missing weights. In response, the host can either train the neural network using training examples or prompt a notification on a user interface to indicate that the input neural network is untrained and requests data representing a trained neural network or data representing the missing weights.

The controller 102 receives data representing a neural network from the host 108 and stores the data in the data memory 104 of the controller 102. In some implementations, the controller 102 can receive the full data at once, or receive a portion of data at a time until the full data has been received.

The controller 102 also receives instructions from the host 108 and stores the received instructions in the instruction memory 106. Similarly, the controller can retrieve portions instructions from the host 108 each at a time of a plurality of times. The controller can send data back to the host 108 as well, the data including partial results or a final result after performing inference computations for a neural network model.

The host determines a respective layer type for each layer of the neural network model according to the received data after receiving data. For example, the host determines if a network layer is a fully-connected layer, element-wise layer, or any other types of layers according to the received data.

The host then selects a (proper) subset of the plurality of layers of the neural network based on the obtained data. (504) specifically, the host selects the subset of the plurality of layers based at least in part on the layer types. The selected subset of the plurality of layers are also referred to as eligible layers in this specification. For example, the host can select all fully-connected layers from all layers to form a subset. As another example, the host selects both fully-connected layers and element-wise layers from all layers to form another subset. In some implementations, the host can select a first subset including all fully-connected layers of the neural network, and a second subset including all element-wise layers of the neural network.

For each layer of a subset of layers, the host assigns a (proper) subset of the plurality of computing units to at least partially perform inference computations associated with the layer. (506) For example, nodal operations for inference computations in a fully-connected layer are distributed among four compute tiles. As another example, nodal operations for inference computations in an element-wise layer are distributed among ten compute tiles.

Each computing unit includes a respective addressable memory unit, so that each computing unit can store partial results in the respective addressable memory unit at a predetermined memory address. For example and in connection with FIG. 2B, the compute 132 includes an addressable memory unit 152, which has four different memory addresses 202a-d, each “pointing” to a respective physical address on the chip memory. Each memory address 202a-d can be re-directed to another physical memory address by issued instructions from a host.

When issuing shared instructions for compute tiles assigned to an eligible layer, the host determines a memory size and a common memory address for each computing unit associated with the eligible layer. (508) The determined memory size can be based at least in part on the type of network layer. For example, the determined memory size is larger for a fully-connected layer than an element-wise layer.

The memory size can also be a pre-determined fixed-size for a given eligible network layer, based on hardware architecture, layer characteristics, and computation requirements. In some implementations, the memory size can alternatively be preset by a user through a user interface. The memory sizes can be 5 Kb, 10 Kb, or 1 Mb, to name just a few examples.

The host 108 generates a shared instruction comprising a memory allocation instruction, when executed by each computing unit associated with the layer, causes the computing unit to store a result of performing the inference computations associated with the layer in the common memory address with the memory size in the addressable memory of the computing unit. (510) For example and in connection with FIG. 2B, compute tiles 132, 134, 136, and 138 are associated with an element-wise layer, and each compute tile stores a partial result of the assigned inference computations at a respective memory address (e.g., 202a, 204a, 206a, and 208a) within the respective addressable memory unit (e.g., 152, 154, 156, and 158). The respective memory addresses 202a, 204a, 206a, and 208a can be considered as the common memory address. However, to be precise, the respective memory addresses 202a, 204a, 206a, and 208a each have an address identifier initially “pointing” to the common memory address of the chip, so that each data store/load process to the memory addresses 202a, 204a, 206a, and 208a is effectively a data store/load process to the common memory address. Alternatively, each memory address 202a, 204a, 206a, and 208a can initially “point” to a respective memory address. However, it can be changed to “point” to the common memory address due to the memory allocation instruction in the shared instruction.

The memory allocation instruction can further include data identifying whether the memory allocation instruction applies to one or more computing units assigned to a respective eligible layer. By doing so, the controller 102, according to the memory allocation instruction, can selectively control the memory storage of each compute tile when necessary. For example, referring back to FIG. 2B, the data can specify that only compute tiles 132, 134, and 136 store partial results at the common memory address with the determined memory size.

The data for identification of computing units can be binary data, including data representing the compute tile node ID and a status flag representing whether the memory allocation applies to the compute tile. For example, 0 represents that the memory allocation instruction is not applicable for a computing unit with the node ID, and 1 represents the instruction applicable to the computing unit.

The memory allocation instruction can also include data tracking partial results stored in the common memory address. The host can issue shared instructions, when executed by corresponding tiles, which cause the controller 102 to keep track of a starting common memory address where a respective result is stored for a layer, and where the respective result will belong to form a final result. More specifically, when one or more compute tiles aggregate partial results to provide one or more layer outputs or a final output for the network, the one or more compute tiles can correctly identify what partial result to aggregate, and where a partial result to aggregate. For example, referring back to FIG. 2B, the compute tile 132 stores partial results at the address 202a “pointing” to the common memory address (or equivalently stores partial results in the common memory address). After each compute tile performs respective inference computations for the layer, the shared instructions issued by the host can identify if the partial result will be used to generate a layer output. If so, the shared instructions issued by the host can further identify how the partial result should be processed in an arithmetic sequence.

As described above, the host can determine a type for a network layer. In response to determining the layer being a fully-connected layer and for each computing unit associated with the fully-connected layer, the host generates a shared instruction, which further includes an aggregation instruction. The aggregation instruction can specify an extra memory address (i.e., a different memory address from the common memory address) used for aggregating a full set of nodal outputs from a preceding eligible layer. More specifically, when executed by each of the computing units assigned to the fully-connected layer, the aggregation instruction can cause each of the compute tiles to aggregate, at the extra common address, the full set of nodal outputs from the partial results stored at the common address associated with the preceding eligible layer.

The extra memory address can be an address accessible for computing units assigned to the fully-connected layer. For example, in connection with FIG. 3, compute tile 132 and compute tile 134 are assigned to a fully-connected layer, the instructions issued by the host when executed can cause the controller 102 to allocate a memory address 302 in the addressable memory unit 312, and a memory address 304 in the addressable memory unit 314. Both memory addresses 302 and 304 “point” to the extra common memory address.

Compute tiles 132 and 134 can aggregate and store in the extra common memory address one or more relevant partial results obtained from a preceding layer. The compute tile 132 and compute tile 134 can mutually access data stored at the extra common memory address.

In some implementations, the aggregation instruction further includes data determining whether one or more of the stored partial results from a preceding layer will be aggregated in the extra memory address by a computing unit associated with the fully-connected layer. This can be useful for parallel computations, particularly when tiles compute nodal outputs redundantly and store respective partial results in the common address. It is therefore needed for tiles in the system to fetch relevant nodal outputs from the common address correctly.

Referring back to FIG. 1, suppose compute tile 148 is associated with the fully-connected layer and assigned to perform operations on the first node of the layer. Compute tile 132 and compute tile 134 are each associated with an eligible preceding layer of the fully-connected layer, in which compute tile 132 is assigned to perform operations on the first half of nodes of the preceding layer, and compute tile 134 is assigned to perform operations on the second half of nodes of the preceding layer. If the compute tile 148 is associated with the fully-connected layer, the aggregation instruction includes data determining that all the relevant partial results stored in the compute tile 132 and compute tile 134 should be aggregated in the extra memory address according to the shared instruction (or more specifically, the aggregation instruction) for the fully-connected layer.

The neural network system implemented by the system 100 of FIG. 1 may be part of a computer vision system. For example, in a computer vision system for an autonomous vehicle or a robotic system. Unfamiliar objects are almost ubiquitous in real-world vision applications due to the so-called ‘long tail’ of objects that occur in real scenes. In another example, the system may be used as part of photo-organizing software which may need to create new categories on-the-fly. In addition to object recognition, the system may perform other computer vision tasks such as object detection and segmentation. Rare and novel objects may also be present in other domains, such as video and speech and the system may be used in conjunction with such other domains.

For example, the neural network system may be used in a language modelling system, an image/video processing system, or an action selection system. For example, tasks may include classification tasks, such as image processing tasks, speech recognition tasks, natural language processing tasks, word recognition tasks, or optical character recognition tasks. In addition, tasks may include reinforcement learning tasks where an agent interacts with one or more real or simulated environments to achieve one or more goals.

For language modeling tasks or translation of text from a source language to a target language using neural networks, the system may be configured to receive an input sequence of source embeddings representing a source sequence of words in a source natural language and to generate an output sequence of target embeddings representing a target sequence of words that is a translation of the source sequence into a target natural language. More generally, the system can be applied to other sequence transduction applications where a source sequence is a mapped to a target sequence.

The input data may comprise, for example, one or more of: image data, moving image/video data, motion data, speech data, audio data, an electronic document, data representing a state of an environment, and/or data representing an action. For example, the image data may comprise color or monochrome pixel value data. Such image data may be captured from an image sensor such as a camera or LIDAR sensor. The audio data may comprise data defining an audio waveform such as a series of values in the time and/or frequency domain defining the waveform; the waveform may represent speech in a natural language. The electronic document data may comprise text data representing words in a natural language. The data representing a state of an environment may comprise any sort of sensor data including, for example: data characterizing a state of a robot or vehicle, such as pose data and/or position/velocity/acceleration data; or data characterizing a state of an industrial plant or data center such as sensed electronic signals such as sensed current and/or temperature signals. The data representing an action may comprise, for example, position, velocity, acceleration, and/or torque control data or data for controlling the operation of one or more items of apparatus in an industrial plant or data center. These data may, generally, relate to a real or virtual, e.g. simulated, environment.

The output data may similarly comprise any sort of data. For example in a classification system the output data may comprise class labels for input data items. In a regression task the output data may predict the value of a continuous variable, for example a control variable for controlling an electronic or electromechanical system such as a robot, vehicle, data center or plant. In another example of a regression task operating on image or audio data the output data may define one or more locations in the data, for example the location of an object or of one or more corners of a bounding box of an object or the time location of a sound feature in an audio waveform. In a reinforcement learning system the output data may comprise, for example, data representing an action, as described above, the action to be performed by an agent operating an in environment, for example a mechanical agent such as a robot or vehicle.

The data representing an action may comprise, for example, data defining an action-value (Q-value) for the action, or data parameterizing a probability distribution where the probability distribution is sampled to determine the action, or data directly defining the action, for example in a continuous action space. Thus in a reinforcement learning system the neural network system may directly parameterize a probability distribution for an action-selection policy or it may learn to estimate values of an action-value function (Q-values). In the latter case multiple memories and respective output networks may share a common embedding network, to provide a Q-value for each available action.

The neural network can be configured to receive any kind of digital data input and to generate any kind of score, classification, or regression output based on the input.

For example, if the inputs to the neural network are images or features that have been extracted from images, the output generated by the neural network for a given image may be scores for each of a set of object categories, with each score representing an estimated likelihood that the image contains an image of an object belonging to the category.

As another example, if the inputs to the neural network are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network is a sequence representing a spoken utterance, the output generated by the neural network may be a score for each of a set of pieces of text, each score representing an estimated likelihood that the piece of text is the correct transcript for the utterance.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

The processes and logic flows described in this specification can be performed by one or more programmable computers executing one or more computer programs to perform functions by operating on input data and generating output(s). The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method comprising:
obtaining data indicating a neural network comprising a plurality of layers;
for each layer in a subset of the plurality of layers:
assigning, from among a plurality of computing units that each include a respective addressable memory unit, a subset of the plurality of computing units to at least partially perform inference computations associated with the layer;
determining a memory size and a common memory address for the respective addressable memory unit of each computing unit in the subset of the plurality of computing units assigned for the layer; and
generating a shared instruction comprising a memory allocation instruction that, when executed by each of the subset of the plurality of computing units, causes the computing unit to store a result of performing inference computations associated with the layer in the determined common memory address with the determined memory size in the addressable memory of the computing unit.

2. The method of claim 1, wherein the subset of the plurality of layers are selected from the plurality of layers, wherein the selecting comprises:
determining a layer type of each of the plurality of layers of the neural network based on the obtained data indicating the neural network.

3. The method of claim 2, wherein the selecting is based at least in part on the determined layer types.

4. The method of claim 2, wherein in response to determining the layer type of the layer being a fully-connected layer, determining an extra memory address different from the common memory address of the computing unit, wherein the shared instruction further comprises an aggregation instruction that, when executed by each of the subset of the plurality of computing units for the layer, causes the computing unit to aggregate one or more results associated with another layer preceding the layer and store the aggregated results in the determined extra memory address in the addressable memory of the computing unit.

5. The method of claim 2, wherein determining the memory size for the respective addressable memory unit of each computing unit in the subset of the plurality of computing units assigned for the layer comprises:
determining the memory size for the respective addressable memory unit of each computing unit in the subset of the plurality of computing units assigned for the layer based at least in part on the determined layer type of the respective layer.

6. The method of claim 1 further comprising, for each layer in the plurality of layers other than the subset of the plurality of layers:
assigning, from among a plurality of computing units that each include a respective addressable memory unit, a second subset of the plurality of computing units to at least partially perform inference computations associated with the layer; and
generating one or more memory allocation instructions each for a corresponding computing unit in the second subset of the plurality of computing units.

7. The method of claim 1, wherein the memory allocation instruction further comprises:
data identifying one or more computing units of the subset of the plurality of computing units to which the memory allocation instruction applies.

8. The method of claim 7, wherein the data identifying the one or more computing units is binary indication data.

9. The method of claim 1, wherein the memory allocation instruction further comprises, for each computing unit of the subset of the plurality of computing units:
data tracking the common memory address of the respective stored result generated by the computing unit.

10. The method of claim 4, wherein the aggregation instruction further comprises data specifying, for each computing unit of the subset of the plurality of computing units for the layer, whether each of the respective results associated with the other layer preceding the layer will be aggregated in the extra memory address in the addressable memory of the computing unit of the layer.

11. The method of claim 1, further comprising:
providing the shared instructions to the plurality of computing units.

12. A method comprising:
providing a set of instructions for performing inference computations for a plurality of layers of a neural network to a system comprising a plurality of computing units, each computing unit including a respective addressable memory,
wherein the set of instructions comprises:
a first memory allocation instruction associated with a first layer in the plurality of layers of the neural network, the first memory allocation instruction identifying a first memory address of the respective addressable memory and a first subset of the plurality of computing units; and
a second memory allocation instruction associated with a second layer in the plurality of layers of the neural network, the second memory allocation instruction identifying a second memory address of the respective addressable memory and a second subset of the plurality of computing units, wherein the second memory address differs from the first memory address, and the second subset differs from the first subset; and
wherein the set of instructions causes the system to:
for each computing unit in the first subset, output results of inference computations associated with the first layer in the plurality of layers to a respective memory address of the computing unit's addressable memory based on the first memory address; and
for each computing unit in the second subset, output results of inference computations associated with the second layer in the plurality of layers to a respective memory address of computing unit's addressable memory based on the second memory address.

13. The method of claim 12, wherein:
the first subset of the plurality of computing units corresponds to a subset of the plurality of computing units across which inference computations associated with the first layer in the plurality of layers are to be distributed; and
the second subset of the plurality of computing units corresponds to a subset of the plurality of computing units across which inference computations associated with the second layer in the plurality of layers are to be distributed.

14. The method of claim 12, wherein the first memory allocation instruction further specifies a first memory size, the second memory allocation instruction further specifies a second memory size, and the set of instructions further causes the system to:
for each computing unit in the first subset, allocate the first memory size at the respective memory address in the respective computing unit's addressable memory based on the first memory address; and
for each computing unit in the second subset, allocate the second memory size at the respective memory address in the respective computing unit's addressable memory based on the second memory address.

15. The method of claim 14, wherein the first memory size is larger than the second memory size.

16. The method of claim 12, wherein the first layer in the plurality of layers comprises a fully-connected layer and the second layer in the plurality of layers comprises an element-wise layer.

17. The method of claim 12, wherein the set of instructions further include the one or more memory allocation instructions associated with each of one or more layers in the plurality of layers different from the first and second layers.

18. The method of claim 16, wherein the set of instructions further comprises a first aggregation instruction associated with the first layer.

19. The method of claim 18, wherein the first aggregation instruction associated with the first layer further causes the system to, when executed by each computing unit of the first subset, allocate an extra memory address associated with respective computing units in the first subset, the extra memory address being different from the first memory address.

20. The method of claim 19, wherein the first aggregation instruction further comprises data determining, for each computing unit of the first subset, whether each of the respective results of inference computations associated with the preceding layer of the first layer will be aggregated in a respective memory address of the computing unit based on the extra memory address.

21. The method of claim 20, wherein in response to determining a result of inference computations associated with the preceding layer of the first layer will be aggregated, the first aggregation instruction associated with the first layer further causes the system to:
aggregate the result of inference computations associated with the preceding layer in a respective memory address of a corresponding computing unit based on the extra memory address.
